(19) United States
(12) Patent Application Publication
(10) Pub. No.: US 2005/0101322 A1
(43) Pub. Date: May 12, 2005

(54) Digital cellular phone system and cellular phone applied thereto

(76) Inventor: Min-Chih Hsuan, Hsinchu (TW)

Correspondence Address: J.C. Patents, Inc., Suite 250, 4 Venture, Irvine, CA, 92618, US

(21) Appl. No.: 10/721,154

(22) Filed: Nov. 24, 2003

(30) Foreign Application Priority Data
Nov. 12, 2003 (TW) 92131625

(51) Int. Cl. H04Q 7/20

(52) U.S. Cl. 455/435.1; 455/435.2; 455/518; 455/558

(57) ABSTRACT

A digital cellular phone system by which a user can set up a group and a cellular phone applied thereto are disclosed. When a registration was sent to the digital cellular phone system, it can be determined whether a member of the group is within the communication range of a same or neighboring base station of a user. When a member is within the communication range of a same base station of the user, the user is informed by short message service. In addition, when the member is within the communication range of a same base station of the user, the user can register for the location information of the member and the distance between the user and the member.

### CROSS-REFERENCE TO RELATED APPLICATION

This application claims the priority benefit of Taiwan application serial no. 92131625, filed on Nov. 12, 2003.

### BACKGROUND OF THE INVENTION

1. Field of the Invention

The present invention relates to a digital cellular phone system and a cellular phone applied thereto, more particularly to a digital cellular phone system having a group communication and a cellular phone applied thereto.

2. Description of the Related Art

GSM is a digital cellular phone system which was originated from Group Special Mobile. The main purpose of GSM serves roaming in Europe. Therefore, the users can use their cellular phones in Europe without any special system setting. Because of the digital processing, it can more efficiently use spectrum than the analog cellular phone system. GSM has the fixed base station structure similar to that of the analog cellular phone system. However, GSM makes improvements in capacity; therefore, it can provide the functions of multiparty conferencing, call barring, caller identification, simultaneous data transmission, etc.

GSM provides digital data transmission for users' information and applies interleaving therein. Digital modulation of RF and frequency hopping can soften the problem of multi-path reception. The spectrum of GSM can be provided from dividing the frequency band between 890-915 MHz and 935-960 MHz by frequency division multiple access (FDMA), time division multiple access (TDMA). As to information communication, GSM can access data of Internet, ISDN, etc. As to information service, users can get short massages with phones or fax messages with fax machines.

As to short message service, GSM has instant messaging structures. The structures serve transmitting simple textual messages between users, which is called short message service (SMS). The SMS server (SMSC) serves this function. Traditionally, the texts of short messages are limited to 160 characters and sent between users. If a user does not contact GSM system, the SMSC will reserve the message and send it to the user once the user connects the system.

In addition to the wireless communication, ICQ having been widely used within Internet is also applied in digital cellular phone systems. The main function of ICQ is for identifying whether other users are surfing on the Internet. Each user using ICQ should install software thereof in their hardware. If the other user is on the Internet, they can send messages or changes files or data for each other. ICQ is faster than e-mail, and the users can receive messages soon. However, ICQ is applied only to computers.

Some services between ICQ and cellular phones have been proposed. Because of these services, users can identify whether the other user is on the internet and send messages by using cellular phones. However, these services are applied between computers and cellular phones.

It is believed that setting a group by a user to identify whether the other user is within the same communication range of a base station has not been disclosed. Moreover, the function of informing a user that the other user is within the same communication range of a base station by using SMS has also not yet disclosed, either.

### SUMMARY OF THE INVENTION

Therefore, the object of the present invention is to provide a digital cellular phone system and a cellular phone applied thereto serving to set up a group by users. When a registration is sent to the digital cellular phone system, the members of the group can be identified and whether the members register the same digital cellular phone system of the user.

Another object of the present invention is to provide a digital cellular phone system and a cellular phone applied thereto serving to set up a group by users. When one member of the group is within the communication range of the base station, the user or the other member can be informed by a short message service (SMS).

The other object of the present invention is to provide a digital cellular phone system and a cellular phone applied thereto serving to set up a group by users. When the user registers for the location of a member of the group and the member is within the communication range of the base station, the location of the member can be identified and the distance between the user and the member can be determined. The user or the other member can get the information by a short message service (SMS).

A further object of the present invention is to provide a digital cellular phone system and a cellular phone applied thereto serving to set up a group by users. When the user registers for the location of a member of the group and the member is within the communication range of a neighboring base station, the location of the member can be identified and the distance between the user and the member can be determined. The user or the other member can get the information by a short message service (SMS).

In order to reach these objects described above, the present invention discloses a digital cellular phone system and a cellular phone applied thereto, the digital cellular phone system having a base station. The digital cellular phone system comprises: a first user registering the digital cellular phone system and keeping contact with the base station, the first user belonged to a group; the first user registering an entry notice function to the digital cellular phone system; and informing the first user when a second user belonged to the group registers the digital cellular phone system and keeps contact with the base station.

In the digital cellular phone system described above, when the first user is informed that the second user registers the base station, the second user is informed switching to a wireless system and is kept contact thereby.

In the digital cellular phone system described above, the digital cellular phone system sets the group of the first user as a group of registration entry notice function when the first user registers the entry notice function. In an exemplary embodiment, the digital cellular phone system modifies a parameter of the entry notice function of the group therein when the first user registers the entry notice function.

In the digital cellular phone system described above, the first user has a cellular phone for registering the cellular phone system and keeping contact with the base station. The cellular phone has some same functions, such as identification function, as of the base station serving for making sure an identity when the second user registers the wireless system. The identification function comprises inputting a password by the second user or identifying a subscriber identity module of the second user.

In the digital cellular phone system described above, the first user is informed by a short message service (SMS). In an exemplary embodiment, the digital cellular phone system informs the first user location information of the second user.

In the digital cellular phone system described above, when the first user is informed the registration and location information of the second user, the second user is informed switching to a wireless system and the wireless system and the location information of the second user serve a contact between the first and the second users. In an embodiment, the cellular phone has some same functions, such as identification function, as of the base station serving for making sure an identity when the second user registers the wireless system. In another embodiment, the cellular phone adjusts a transmission power of the wireless system by the location information of the second user.

In order to make the aforementioned and other objects, features and advantages of the present invention understandable, a preferred embodiment accompanied with figures is described in detail below.

### BRIEF DESCRIPTION OF THE DRAWINGS

FIG. 1 is a schematic structure showing an exemplary digital cellular phone system applied to a GSM system.

FIGS. 2 and 3 are schematic structures showing exemplary digital cellular phone systems of the present invention.

FIGS. 4 and 5 are operational flows of the exemplary digital cellular phone systems of the present invention shown in FIGS. 2 and 3.

### DESCRIPTION OF SOME EMBODIMENTS

In an embodiment of the digital cellular phone system of the present invention, the user can set up a group. When a registration is sent to the digital cellular phone system, the members of the group can be identified and whether the members register the same digital cellular phone system of the user. In an exemplary embodiment, when one member of the group is within the communication range of the base station, the user or the other member can be informed by a short message service (SMS).

Additionally, in another embodiment, when the user registers for the location of a member of the group and the member is within the communication range of a neighboring base station, the location of the member can be identified and the distance between the user and the member can be determined. The user or the other member can get the information by a short message service (SMS).

Moreover, the present invention adapted to the cellular phones of the digital cellular phone system described above will switch to a wireless system and use the wireless system keeping contact with a member when a registration of the member of the group is received. Therefore, the issue of switching base stations does not exist. In an embodiment, the cellular phone has same identification function of the base station serving for making sure an identity when the second user registers the wireless system. The identification function comprises: inputting a password by the second user or identifying a subscriber identity module of the second user.

In an embodiment, the present invention is adapted to the cellular phones of the digital cellular phone system, which can determine the location of the other users. When the first user is informed the registration and location information of the second user, the second user is informed switching to a wireless system and the wireless system and the location information of the second user serve a contact between the first and the second users. Therefore, the cellular phone adjusts a transmission power of the wireless system by the location information of the second user and uses the wireless system keeping contact with the member. For example, if it is a far distance, an enhanced mode is applied with increased power. If it is a short distance, a normal mode or power- saving mode is applied for saving costs resulting from the power consumption.

The digital cellular phone system of the present invention serves for the communication between cellular phones no matter which base station is applied. According to the operation of cellular phones, the cellular phones can send short massages to a member of the group when the member is within the communication range of a base station.

In the consideration of the density of the base station, the communication range of GSM 900 structure system is about 3-50 Km depending on the topography of earth and buildings thereon. According to GSM 1800 structure system, the communication range is about 1-5 Km depending on the topography of earth and buildings thereon. It is possible the distance of a member from a base station is about 30-40 Km when the locations of base stations are not very close to each other. The identification of location is, therefore, required. In addition, if a cellular phone can serve as a base station, location identification and transmission power adjustment are required for reducing power consumptions.

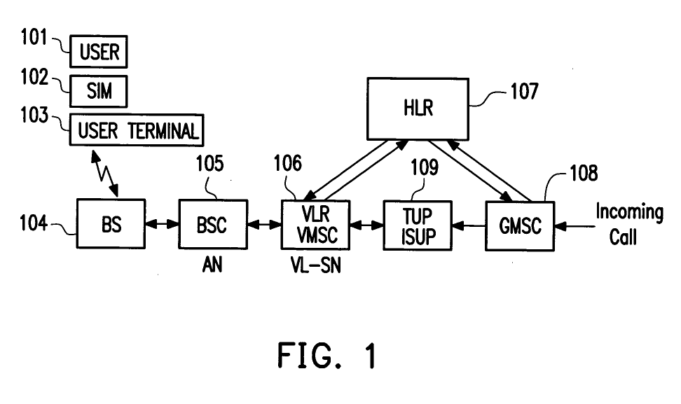

FIG. 1 is a schematic structure showing an exemplary digital cellular phone system applied to a GSM system. The network of the digital cellular phone system comprises a user terminal 103. When a user 101 inserts a subscriber identity module (SIM) 102 thereto, the user terminal 103 becomes a port of the network of the digital cellular phone system. By wireless communication, the terminal 103 keeps contact with a base station 104. The user terminal 103 depends on the equipment of the user 101. Home location register (HLR) 107 controls registration and service management and termination call management. A visited mobile switching center (VMSC) 106 controls registration and service management and termination call management of the user terminal 103, which includes a visitor location register (VLR). The function of routing between the cellular ports for communication depends on the roaming number from the signal determined by the HLR 107 between a gateway mobile switching center (GMSC) 108 and the VMSC 106. The method of determining the signal by the HLR 107 between a gateway mobile switching center (GMSC) 108 and the VMSC 106 relies on signaling protocol of mobile application part (MAP). It should be noted that the signaling between the VMSC and GMSC is through HLR, but finished by the device 109. The device 109 is composed of the telephone user part (TUP) and integrated service user part (ISUP) of the CCITT. After the transformation, the gateways of cellular phone and toll phones can communicate to each other. The base station 104 is controlled by a base station controller (BSC) 105, which also is an access node.

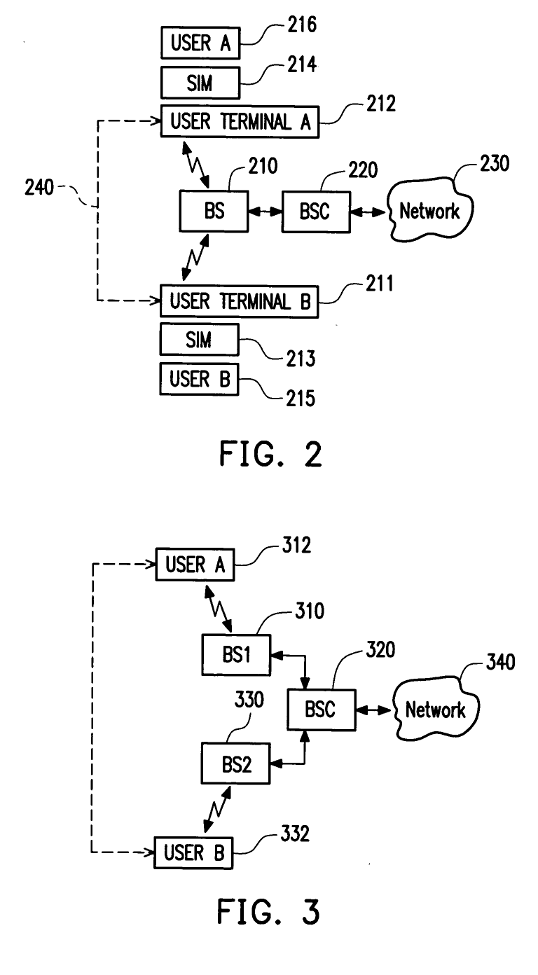

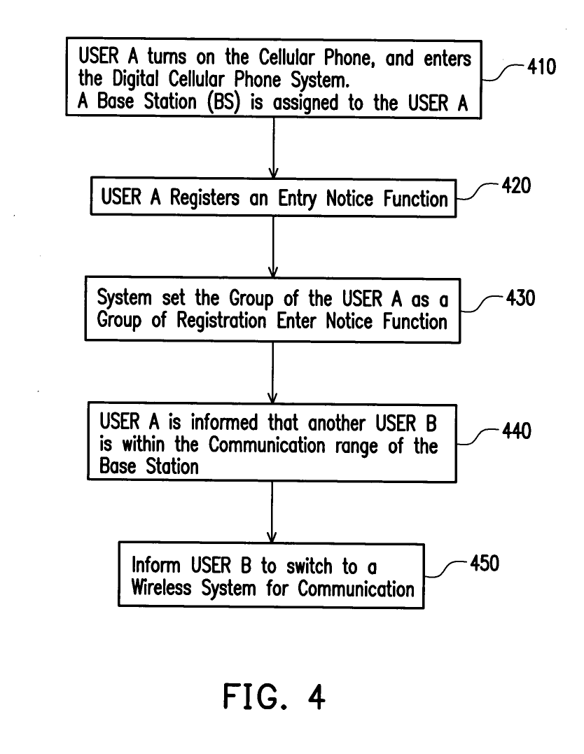

FIG. 2 is a schematic structure showing an exemplary digital cellular phone system of the present invention. FIG. 4 is an operational flow of the exemplary digital cellular phone system of the present invention shown in FIG. 2. The system comprises user terminal 212, SIM 214, user 216, BS 210 and BSC 220. The BSC 220 communicates with the network 230 of the digital cellular phone system as shown in FIG. 1.

When the user 216 inserts the SIM 214, the user terminal 212 becomes a communication port of the digital cellular phone system and keeps contact with BS 210 in step 410 of FIG. 4. The user terminal 212 depends on the equipment, i.e., cellular phones, of the user 216. The user 216 belongs to a group. In step 420, the user 216 registers an entry notice function to the digital cellular phone system and determines whether a member belonged to the group registers the digital cellular phone system and keeps contact with the BS 210.

Then, the digital cellular phone system sets the group of the user 216 as a group of registration entry notice function when the user 216 registers the entry notice function in step 430. In an exemplary embodiment, the digital cellular phone system modifies a parameter, such as the parameter of the entry notice function of the group. It depends on the design of the system.

When another user 215 inserts a SIM 213, the user terminal 211 becomes a communication port of the digital cellular phone system and keeps contact with BS 210. As shown in step 440 of FIG. 4, the user 216 is informed that the user 215 is within the communication range of the base station. When the user 216 is informed that the user 215 registers the base station, the user 215 is informed switching to a wireless system and is kept contact thereby. Therefore, the issue of switching base stations does not exist. In an embodiment, the cellular phone of the user 216 has same identification function of the base station serving for making sure an identity when the user 215 registers the wireless system. The identification function comprises: inputting a password by the second user or identifying a subscriber identity module of the second user.

FIG. 3 is a schematic structure showing another exemplary digital cellular phone system of the present invention. The system comprises user terminal 312, BS1 310, BSC 320, BS2 330 neighboring to the BS1 310. The BSC 320 communicates with the network 340 of the digital cellular phone system as shown in FIG. 1.

The user terminal 312 becomes a communication port of the digital cellular phone system and keeps contact with BS1 310 in step 410 of FIG. 4. The user respond to the user terminal 312 belongs to a group. In step 420, the user registers an entry notice function to the digital cellular phone system and determines whether a member belonged to the group registers the digital cellular phone system and keeps contact with the BS1 310 and BS2 330.

Then, the digital cellular phone system sets the group of the user as a group of registration entry notice function when the user registers the entry notice function in step 430. In an exemplary embodiment, the digital cellular phone system modifies a parameter, such as the parameter of the entry notice function of the group. It depends on the design of the system.

When the user terminal 332 respond to another user becomes a communication port of the digital cellular phone system and keeps contact with BS2 330. As shown in step 440 of FIG. 4, the user is informed that another user is within the communication range of the base station. As in step 450, when the user is informed that another user registers the base station, another user is informed switching to a wireless system and is kept contact thereby. Therefore, the issue of switching base stations does not exist. In an embodiment, the cellular phone of the user has same identification function of the base station serving for making sure an identity when another user registers the wireless system. The identification function comprises: inputting a password by the second user or identifying a subscriber identity module of the second user.

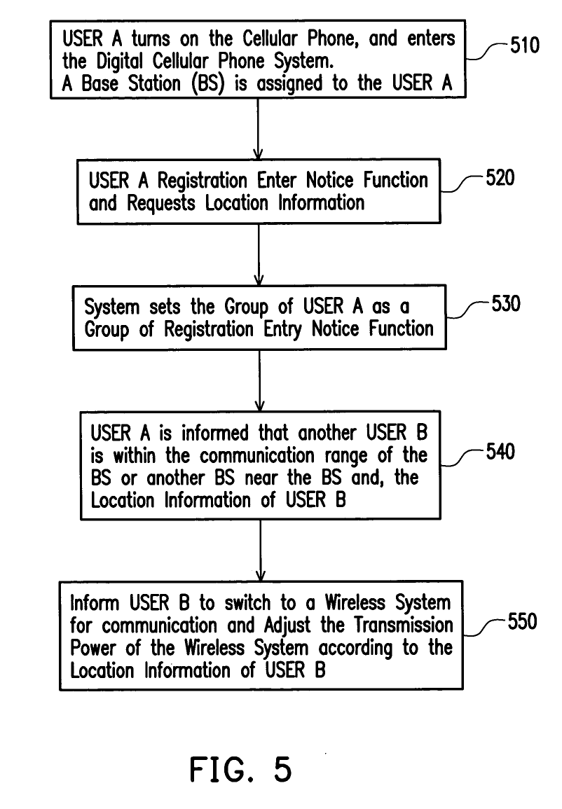

FIG. 5 is an operational flow of the exemplary digital cellular phone system of the present invention shown in FIG. 3.

The user terminal becomes a communication port of the digital cellular phone system and keeps contact with BS in step 510 of FIG. 5. The user respond to the user terminal belongs to a group. In step 520, the user registers an entry notice function to the digital cellular phone system, requests the location information of a member and determines whether the member belonged to the group registers the digital cellular phone system and keeps contact with the BS.

Then, the digital cellular phone system sets the group of the user as a group of registration entry notice function when the user registers the entry notice function in step 530. In an exemplary embodiment, the digital cellular phone system modifies a parameter, such as the parameter of the entry notice function of the group. It depends on the design of the system.

When the user terminal respond to another user becomes a communication port of the digital cellular phone system and keeps contact with BS. As shown in step 540 of FIG. 5, the user is informed that another user is within the communication range of the base station and the location of another user. Then the user knows the distance between the user and another user. When the user is informed that another user registers the base station, another user is informed switching to a wireless system and is kept contact thereby in step 550. Therefore, the issue of switching base stations does not exist. In an embodiment, the cellular phone of the user has same identification function of the base station serving for making sure an identity when another user registers the wireless system. The identification function comprises inputting a password by the second user or identifying a subscriber identity module of the second user.

In another embodiment, when the user is informed that another user is within the communication range of the same base station or a neighboring base station thereto and the location of another user, the user or the other member can get the information by a short message service (SMS).

In an embodiment, when the first user is informed the registration and location information of the second user, the second user is informed switching to a wireless system and the wireless system and the location information of the second user serve a contact between the first and the second users. Therefore, the cellular phone adjusts a transmission power of the wireless system by the location information of the second user and uses the wireless system keeping contact with the member. For example, if it is a far distance, an enhanced mode is applied with increased power. If it is a short distance, a normal mode or power-saving mode is applied for reducing costs resulting from the power consumption.

Please referring to FIG. 1, a description of location identification of cellular phones is disclosed. When the user 101 is moving, the location of the user 101 will change from a base station to another base station. The user's cellular phone, i.e., the user terminal 103, detects the change of base station and feeds back the change to HLR 107 for registering the location of the user. Because the location of the user terminal 103 is not fixed, broadcast control channel (BCCH) signals from base stations must be scanned. The user terminal 103 detects the BCCH and records the signals. By three-point method, choosing three base stations sending out the strongest signals detected by the cellular phone is used to identify the location.

As to the distance between the base station and the cellular phone, it depends. on the characteristic of GSM system. If the GSM system having time division multiple access (TDMA) technology is applied, it has an adaptive frame alignment function (AFA). Because a TDMA frame comprises eight time slots, TDMA frames are aligned to each other in tunnel. For base station, there is a three-time slot delay, which is called timing advance (TA) when TDMA frames are downloaded. It serves the function of AFA.

When the signals received by the base station, TA is measured. The practical and theoretical TA can be used to determine the distance between the base station and the cellular phone. According to the three distances between the base stations and the cellular phone and the locations of the base stations, the location of the cellular phone can be determined. The distance deviation can be controlled within 200-300 m.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

1. A digital cellular phone system having a base station, the digital cellular phone comprising:
a first user registering the digital cellular phone system and keeping contact with the base station, the first user belonged to a group;
the first user registering an entry notice function to the digital cellular phone system; and
informing the first user when a second user belonged to the group registers the digital cellular phone system and keeps contact with the base station.

2. The digital cellular phone system of claim 1, wherein when the first user is informed that the second user registers the base station, the second user is informed switching to a wireless system and is kept contact thereby.

3. The digital cellular phone system of claim 2, wherein the first user has a cellular phone for registering the cellular phone system and keeping contact with the base station and the cellular phone has an identification function of the base station serving for making sure an identity when the second user registers the wireless system.

4. The digital cellular phone system of claim 3, wherein the identification function comprises inputting a password by the second user.

5. The digital cellular phone system of claim 3, wherein the identification function comprises identifying a subscriber identity module of the second user.

6. The digital cellular phone system of claim 1, wherein the first user is informed by a short message service (SMS).

7. The digital cellular phone system of claim 1, wherein the digital cellular phone system informs the first user location information of the second user.

8. The digital cellular phone system of claim 7, wherein when the first user is informed the registration and location information of the second user, the second user is informed switching to a wireless system and the wireless system and the location information of the second user serve a contact between the first and the second users.

9. The digital cellular phone system of claim 8, wherein the first user has a cellular phone for registering the cellular phone system and keeping contact with the base station and the cellular phone has an identification function of the base station serving for making sure an identity when the second user registers the wireless system.

10. The digital cellular phone system of claim 9, wherein the cellular phone adjusts a transmission power of the wireless system by the location information of the second user.

11. The digital cellular phone system of claim 1, wherein the digital cellular phone system sets the group of the first user as a group of registration entry notice function when the first user registers the entry notice function.

12. The digital cellular phone system of claim 1, wherein the digital cellular phone system modifies a parameter of the entry notice function of the group therein when the first user registers the entry notice function.

13. A digital cellular phone system having a base station and a second base station near thereto, the digital cellular phone system comprising:
a first user registering the digital cellular phone system and keeping contact with the base station, the first user belonged to a group;
the first user registering an entry notice function to the digital cellular phone system; and
informing the first user when a second user belonged to the group registers the digital cellular phone system and keeps contact with the base station.

14. The digital cellular phone system of claim 13, wherein when the first user is informed that the second user registers the second base station near to the first base station, the second user is informed switching to a wireless system and is kept contact thereby.

15. The digital cellular phone system of claim 14, wherein the first user has a cellular phone for registering the cellular phone system and keeping contact with the first base station and the cellular phone has an identification function of the first base station serving for making sure an identity when the second user registers the wireless system.

16. The digital cellular phone system of claim 15, wherein the identification function comprises inputting a password by the second user.

17. The digital cellular phone system of claim 15, wherein the identification function comprises identifying a subscriber identity module of the second user.

18. The digital cellular phone system of claim 13, wherein the first user is informed by a short message service (SMS).

19. The digital cellular phone system of claim 13, wherein the digital cellular phone system informs the first user location information of the second user.

20. The digital cellular phone system of claim 19, wherein when the first user is informed the registration and location information of the second user, the second user is informed switching to a wireless system and the wireless system and the location information of the second user serve a contact between the first and the second users.

21. The digital cellular phone system of claim 20, wherein the first user has a cellular phone for registering the cellular phone system and keeping contact with the base station and the cellular phone has an identification function of the base station serving for making sure an identity when the second user registers the wireless system.

22. The digital cellular phone system of claim 21, wherein the cellular phone adjusts a transmission power of the wireless system by the location information of the second user.

23. The digital cellular phone system of claim 13, wherein the digital cellular phone system sets the group of the first user as a group of registration entry notice function when the first user register the entry notice function.

24. The digital cellular phone system of claim 13, wherein the digital cellular phone system modifies a parameter of the entry notice function of the group therein when the first user register the entry notice function.

25. A cellular phone adapted to register a entry notice function of a digital cellular phone system, the digital cellular phone system having a base station, the cellular phone serving for registering the digital cellular phone system and keeping contact with the base station, a first user of the cellular phone belonged to a group, the cellular phone informed when the cellular registers an entry notice function of the digital cellular phone system and a second user belonged to the group registers the digital cellular phone system and keeps contact with the base station.

26. The cellular phone of claim 25, wherein when the first user is informed that the second user registers the base station, the second user is informed switching to a wireless system and is kept contact therewith by another cellular phone of the second user.

27. The cellular phone of claim 26, wherein the cellular phone has an identification function of the base station serving for making sure an identity when the second user registers the wireless system.

28. The cellular phone of claim 27, wherein the identification function comprises inputting a password by the second user.

29. The cellular phone of claim 27, wherein the identification function comprises identifying a subscriber identity module of the second user.

30. The cellular phone of claim 25, wherein the cellular phone is informed by a short message service (SMS).

31. The cellular phone of claim 25, wherein the digital cellular phone system informs the first user location information of the second user.

32. The cellular phone of claim 31, wherein when the cellular phone is informed the registration and location information of the second user, the second user is informed switching to a wireless system and the wireless system and the location information of the second user serve a contact with the another cellular phone the second user.

33. The cellular phone of claim 32, wherein the cellular phone has an identification function of the base station serving for making sure an identity when the second user registers the wireless system.

34. The cellular phone of claim 33, wherein the identification function comprises inputting a password by the second user.

35. The cellular phone of claim 33, wherein the identification function comprises identifying a subscriber identity module of the second user.

36. A cellular phone adapted to register a entry notice function of a digital cellular phone system, the digital cellular phone system having a first and a second base stations, the cellular phone serving for registering the digital cellular phone system and keeping contact with the first base station, a first user of the cellular phone belonged to a group, the cellular phone informed when the cellular registers an entry notice function of the digital cellular phone system and a second user belonged to the group registers the digital cellular phone system and keeps contact with the second base station.

37. The cellular phone of claim 36, wherein when the first user is informed that the second user registers the second base station, the second user is informed switching to a wireless system and is kept contact therewith by another cellular phone of the second user.

38. The cellular phone of claim 36, wherein the cellular phone has an identification function of the base station serving for making sure an identity when the second user registers the wireless system.

39. The cellular phone of claim 38, wherein the identification function comprises inputting a password by the second user.

40. The cellular phone of claim 38, wherein the identification function comprises identifying a subscriber identity module of the second user.

41. The cellular phone of claim 36, wherein the cellular phone is informed by a short message service (SMS).

42. The cellular phone of claim 36, wherein the digital cellular phone system informs the first user location information of the second user.

43. The cellular phone of claim 42, wherein when the cellular phone is informed the registration and location information of the second user, the second user is informed switching to a wireless system and the wireless system and the location information of the second user serve a contact with the another cellular phone the second user.

44. The cellular phone of claim 43, wherein the cellular phone has an identification function of the base station serving for making sure an identity when the second user registers the wireless system.

45. The cellular phone of claim 44, wherein the identification function comprises inputting a password by the second user.

46. The cellular phone of claim 44, wherein the identification function comprises identifying a subscriber identity module of the second user.
